(19) United States
(12) Patent Application Publication
(10) Pub. No.: US 2025/0197701 A1
(43) Pub. Date: Jun. 19, 2025

(54) TWO-COMPONENT POLYURETHANE ADHESIVE COMPOSITION

(71) Applicant: ROHM AND HAAS ELECTRONIC MATERIALS (SHANGHAI) LTD., Shanghai (CN)

(72) Inventor: Zhenghe ZHANG, Shanghai (CN)

(21) Appl. No.: 18/839,835

(22) PCT Filed: May 11, 2022
(86) PCT No.: PCT/CN2022/092256

§ 371 Date: Aug. 20, 2024

(51) Int. Cl. C09J 175/04; C08G 18/08; C08G 18/10; C08G 18/24; C08G 18/28; C08G 18/48; C08K 3/22; C08K 7/18; C09J 9/00

(52) U.S. Cl. CPC C09J 175/04; C08G 18/0838; C08G 18/10; C08G 18/242; C08G 18/283; C08G 18/4816; C08G 18/4854; C08K 3/22; C08K 7/18; C09J 9/00; C08G 2170/00; C08K 2003/2227; C08K 2201/005; C08K 2201/014

(57) ABSTRACT

Provided herein is a two-component polyurethane adhesive composition.

### FIELD OF INVENTION

The present invention relates to the field of two-component polyurethane adhesive compositions.

### BACKGROUND OF THE INVENTION

The demand for affordable, higher autonomy range electrical vehicles has led to a rapid acceleration in innovation in electric vehicle (EV) battery concepts. Higher-energy-density, lighter, higher durability and more economical EV battery concepts have been developed during the last decade.

The innovation efforts are primarily focused in two directions: 1. to extend the autonomy range by increasing the energy-packing density, and 2. to reduce the price of batteries. There are several strategies in the market to achieve a higher energy-density of the cell in order to save weight and increase the battery autonomy range, and all of them include a thermal management concept to optimize operation conditions and lifetime of the battery. Typical cells generate heat during standard operation conditions and charging. The optimal operating temperature of the cells lies between 25-40° C. The heat generated by the cells during operation is dissipated to a cooling plate. The cells or modules are connected to the cooling plate through a thermally-conductive material. In order to increase the mechanical stability of the battery a thermally conductive adhesive is needed.

For the purposes of adhering battery modules, it is desirable that the adhesive have a reasonably long working time. Working time is the time from mixing of the components of an adhesive until the adhesive has cured enough that the parts of an adhered assembly can no longer be moved with respect to each other. Longer working times permit flexibility in the assembly process, and in the case of thermally-conductive adhesives, provides time for the adhesive to penetrate into relatively small cavities and fully surround the battery components.

A need remains for adhesives that are thermally-conductive and which show a working time of greater than 30 minutes.

### SUMMARY OF THE INVENTION

In a first aspect, the invention provides a two-component thermally-conductive polyurethane adhesive, comprising:
(A) Component A:
(ai) an NCO-terminated prepolymer made by reacting at least one polyether mono-ol of molecular weight (Mₙ) greater than 800 Da with at least one polyisocyanate selected from aliphatic polyisocyanates and mixtures of 2,4′-methylene-bis-(phenyl isocyanate) (MDI) and 4,4′-MDI;
(B) Component B:
(bi) at least one polyol; and
(bii) a catalyst capable of catalyzing the reaction of OH groups with NCO groups;
wherein Component A and/or Component B comprise aluminium trihydroxide (ATH) in an amount such that when Component A and B are mixed to produce an adhesive mixture, the content of ATH in the adhesive mixture is at least 40 wt % based on the total weight of the adhesive mixture, and wherein Component A and/or Component B comprise alumina in an amount such that when Component A and B are mixed to produce an adhesive mixture, the content of alumina in the adhesive mixture is at least 15 wt % based on the total weight of the adhesive mixture.

In a second aspect, the invention provides a kit for producing a thermally-conductive polyurethane adhesive, comprising:
(A) Component A:
(ai) an NCO-terminated prepolymer made by reacting at least one polyether mono-ol of molecular weight (Mₙ) greater than 800 Da with at least one polyisocyanate selected from aliphatic polyisocyanates and mixtures of 2,4′-methylene-bis-(phenyl isocyanate) (MDI) and 4,4′-MDI;
(B) Component B:
(bi) at least one polyol; and
(bii) a catalyst capable of catalyzing the reaction of OH groups with NCO groups;
wherein Component A and/or Component B comprise aluminium trihydroxide (ATH) in an amount such that when Component A and B are mixed to produce an adhesive mixture, the content of ATH in the adhesive mixture is at least 40 wt % based on the total weight of the adhesive mixture, and wherein Component A and/or Component B comprise alumina in an amount such that when Component A and B are mixed to produce an adhesive mixture, the content of alumina in the adhesive mixture is at least 15 wt % based on the total weight of the adhesive mixture.

In a third aspect, the invention provides a method for adhering two or more substrates, comprising the steps:
(1) providing an adhesive comprising:
(A) Component A:
(ai) an NCO-terminated prepolymer made by reacting at least one polyether mono-ol of molecular weight (Mₙ) greater than 800 Da with at least one polyisocyanate selected from aliphatic polyisocyanates and mixtures of 2,4′-methylene-bis-(phenyl isocyanate) (MDI) and 4,4′-MDI;
(B) Component B:
(bi) at least one polyol; and
(bii) a catalyst capable of catalyzing the reaction of OH groups with NCO groups;
wherein Component A and/or Component B comprise aluminium trihydroxide (ATH) in an amount such that when Component A and B are mixed to produce an adhesive mixture, the content of ATH in the adhesive mixture is at least 40 wt % based on the total weight of the adhesive mixture, and wherein Component A and/or Component B comprise alumina in an amount such that when Component A and B are mixed to produce an adhesive mixture, the content of alumina in the adhesive mixture is at least 15 wt % based on the total weight of the adhesive mixture;
(2) mixing Component A and Component B to produce an adhesive mixture;
(3) applying the adhesive mixture to a first substrate;
(4) bringing the first substrate into adhesive contact with a second substrate;
(5) allowing the adhesive mixture to cure.

In a fourth aspect, the invention provides an adhered assembly, comprising:
(1) a first substrate;
(2) a second substrate adhered to the first substrate;
wherein the first substrate and the second substrate are adhered one to the other by an adhesive made by mixing together the following Component A and Component B:
(A) Component A:
(ai) an NCO-terminated prepolymer made by reacting at least one polyether mono-ol of molecular weight (Mₙ) greater than 800 Da with at least one polyisocyanate selected from aliphatic polyisocyanates and mixtures of 2,4′-methylene-bis-(phenyl isocyanate) (MDI) and 4,4′-MDI;
(B) Component B:
(bi) at least one polyol; and
(bii) a catalyst capable of catalyzing the reaction of OH groups with NCO groups;
wherein Component A and/or Component B comprise aluminium trihydroxide (ATH) in an amount such that when Component A and B are mixed to produce an adhesive mixture, the content of ATH in the adhesive mixture is at least 40 wt % based on the total weight of the adhesive mixture, and wherein Component A and/or Component B comprise alumina in an amount such that when Component A and B are mixed to produce an adhesive mixture, the content of alumina in the adhesive mixture is at least 15 wt % based on the total weight of the adhesive mixture.

### DETAILED DESCRIPTION OF THE INVENTION

The inventors have found that it is possible to achieve prolonged working times and slow development of compression force in a thermally-conductive polyurethane adhesive by using an isocyanate component that comprises a prepolymer made by reacting at least one polyether mono-ol of molecular weight (Mₙ) greater than 800 Da with at least one polyisocyanate selected from aliphatic polyisocyanates and mixtures of 2,4′-methylene-bis-(phenyl isocyanate) (MDI) and 4,4′-MDI, and by using a mixture of ATH and alumina as filler.

### Definitions and Abbreviations

MDI Methylene-bis-(phenyl isocyanate)
HDI Hexamethylene diisocyanate
IPDI isophorone diisocyanate
PU polyurethane
GPC gel permeation chromatography
RH relative humidity
ATH aluminium trihydroxide

Equivalent and molecular weights are measured by gel permeation chromatography (GPC) with a Malvern Viscothek GPC max equipment. Tetrahydrofuran (THF) was used as an eluent, PL GEL MIXED D (Agilent, 300*7.5 mm, 5 μm) was used as a column, and MALVERN Viscotek TDA (integrated refractive index viscometer and light scattering) was used as a detector.

Particle sizes of ATH were measured using laser diffraction with water containing 0.01 wt % sodium pyrophosphate as the suspending medium.

### Component A (Isocyanate)

Component A comprises an NCO-terminated prepolymer made by reacting at least one polyether mono-ol of molecular weight (Mₙ) greater than 800 Da with at least one polyisocyanate.

The polyether mono-ol is preferably selected from monoethers of poly(C₂₋₄-alkylene oxide) diols, i.e. one of the terminal OH groups of the diol is replaced with a C₁₋₆ ether group, and monoesters of poly(C₂₋₄-alkylene oxide) diols, i.e. one of the terminal OH groups of the diol is replaced with a C₂₋₆ ester group.

In a preferred embodiment, the polyether mono-ol is selected from monoethers of poly(ethylene oxide) diols, monoethers of poly(propylene oxide) diols, monoethers of poly(butylene oxide) diols, and mixtures of these.

In a more preferred embodiment, the polyether mono-ol is selected from monoethers of poly(propylene oxide) diols.

Methyl, ethyl and propyl monoethers are preferred, with methyl ethers being particularly preferred.

In a preferred embodiment, the polyether mono-ol is selected from monomethyl ethers of poly(propylene oxide) diols.

The polyether mono-ol has a molecular weight (Mₙ) greater than 800 Da, and preferably less than 2,000 Da, more preferably less than 1,500 Da, more particularly preferably 1,000 Da.

In a preferred embodiment, the polyether mono-ol is a monomethyl ether of poly(propylene oxide) diol, in particular poly(propylene glycol) having a molecular weight (Mₙ) of 800-2,000 Da, more preferably 800-1,500 Da.

In a particularly preferred embodiment, the polyether mono-ol is a monomethyl ether of poly(propylene oxide) diol, in particular poly(propylene glycol) having a molecular weight (Mₙ) of 1,000 Da.

The polyisocyanate is selected from aliphatic polyisocyanates and mixtures of 2,4′-MDI and 4,4′-MDI.

In a preferred embodiment, the polyisocyanate is aliphatic, with isophorone diisocyanate (IPDI), Dicyclohexyl methane diisocyanate (HMDI), and hexamethylene diisocyanate (HDI), and mixtures of these being particularly preferred.

In another preferred embodiment, the polyisocyanate is a mixture of 2,4′-MDI and 4,4′-MDI. More preferably the weight ratio of 2,4′-MDI to 4,4′-MDI is 0.667-1.5, more particularly preferably 0.8-1.5, even more particularly preferably 1-1.5.

Particularly preferred is a mixture of 2,4′-MDI and 4,4-MDI, with a 1:1 weight ratio of 2,4′-MDI and 4,4-MDI.

The NCO-terminated prepolymer of Component A is made by reacting the at least one polyether mono-ol with the at least one polyisocyanate. This reaction is preferably carried out under dry and inert conditions, in particular under vacuum. In a preferred embodiment, the at least one polyether mono-ol is first dried under vacuum and elevated temperature (>100° C.), and cooled (e.g. to 80° C.) before the at least one polyisocyanate is added under vacuum. The mixture is allowed to react under vacuum for 1-2 hours. The prepolymer the resulting reaction mixture and is used without purification.

The at least one polyisocyanate is used in an amount such that there is an excess of NCO groups with respect to the mono-ol OH groups. In a preferred embodiment, the at least one polyisocyanate is used in a stoichiometric excess of 2-15-fold with respect to the mono-ol, more preferably 8-12-fold with respect to the mono-ol, particularly preferably 10-fold with respect to the mono-ol.

In a preferred embodiment, the prepolymer is made by reacting poly(propylene glycol) mono-methyl ether with a mixture of 2,4′-MDI and 4,4′-MDI.

In another preferred embodiment, the prepolymer is made by reacting poly(propylene glycol) mono-methyl ether of molecular weight (Mₙ) 800-1,500 Da with a mixture of 2,4′-MDI and 4,4′-MDI.

The at least one polyether mono-ol is preferably used in Component A at 5-20 wt %, more preferably 6-10 wt %, particularly preferably 8-9 wt %, based on the total weight of Component A, it being understood that the polyether mono-ol is in the form of prepolymer.

The at least one polyisocyanate is preferably used in Component A at 5-20 wt %, more preferably 6-15 wt %, more particular preferably 10-11 wt %, based on the total weight of Component A.

The NCO-terminated prepolymer is preferably made with 30-55 wt % polyether mono-ol, more preferably 35-50 wt %, particularly preferably 42-45 wt %, based on the total weight of the prepolymer.

The NCO-terminated prepolymer is preferably made with 40-65 wt % diisocyanate, more preferably 45-60 wt %, particularly preferably 50-58 wt %, based on the total weight of the prepolymer.

In a preferred embodiment, the prepolymer is made with 30-55 wt % polyether mono-ol, more preferably 35-50 wt %, particularly preferably 42-45 wt %, based on the total weight of the prepolymer and 40-65 wt % diisocyanate, more preferably 45-60 wt %, particularly preferably 50-58 wt %, based on the total weight of the prepolymer.

The prepolymer preferably is used in Component A at 15-30 wt %, more preferably 16-25 wt %, more particularly preferably 18-20 wt %, based on the total weight of Component A.

Component A may additionally comprise a silane comprising a hydrolysable silyl alkoxy group covalently bonded to a C₈₋₂₀ alkyl group. Examples of such silanes include trialkoxy-C₈₋₂₀-alkyl silanes, in particular trimethoxy-C₈₋₂₀-alkyl silanes and triethoxy-C₈₋₂₀-alkyl silanes, with trimethoxy-C₈₋₂₀-alkyl silanes being particularly preferred. In a preferred embodiment, Component A comprises hexadecyl-trimethoxy silane.

If used, the silane is preferably present in Component A at 0.25-3 wt %, more preferably 0.5-2 wt %, particularly preferably 0.75-1.2 wt %, based on the total weight of Component A.

In a preferred embodiment, Component A comprises hexadecyl-trimethoxy silane at 0.25-3 wt %, more preferably 0.5-2 wt %, particularly preferably 0.75-1.2 wt %, based on the total weight of Component A.

Component A may additionally comprise ATH and alumina, as will be described in more detail below.

Component A may additionally comprise fibrous fillers, such as wollastonite. If used, wollastonite is preferably present at 0.5-4 wt %, more preferably 1-3 wt %, more particularly preferably 1.7-2.2 wt %, based on the total weight of Component A.

Component A may additionally comprise fumed silica. If used, fumed silica is preferably present at 0.75-2 wt %, more preferably 1-2 wt %, based on the total weight of Component A.

Component A is typically formulated by drying the solid ingredients, such as ATH and alumina, wollastonite, fumed silica at elevated temperature under vacuum. Preferably drying is carried out until the moisture content is 300 ppm or less. The prepolymer and silane, if used, are added to the dry ingredients and mixed to homogeneity under reduced pressure, and Component A is then stored in a moisture-proof container.

### Component B (Polyol)

Component B comprises (bi) at least one polyol; and (bii) a catalyst capable of catalyzing the reaction of OH groups with NCO groups.

The at least one polyol preferably comprises polyols having molecular weights of less than 1,500 Da, more preferably less than or equal to 1,000 Da.

The at least one polyol preferably comprises diols, triols and mixtures of these. In a preferred embodiment, the at least one polyol comprises at least one diol, in particular a polyether-based diol. In a particularly preferred embodiment, the at least one polyol comprises a poly(propylene oxide)-based diol.

In a more preferred embodiment, the at least one polyol comprises a mixture of diols and triols.

In another preferred embodiment, the at least one polyol comprises diols, triols and mixtures of these, all having molecular weights of less than 1,500 Da, more preferably less than 1,000 Da. In a preferred embodiment, the at least one polyol comprises a mixture of diols and triols, having molecular weights of less than 1,500 Da, more preferably less than 1,000 Da.

In a preferred embodiment, the at least one polyol comprises a polyether polyol. Preferred polyether polyols are selected from poly(C₂₋₄-alkylene oxide)-based polyols, particularly poly(ethylene oxide)-based, poly(propylene oxide)-based, poly(butylene oxide)-based polyols, and mixtures of these. In a particularly preferred embodiment the polyether polyol is selected from poly(propylene oxide)-based polyols.

In another preferred embodiment, the at least one polyol comprises a triol. The triol may be, for example, poly(C₂₋₄-alkylene oxide)-based, in particular poly(propylene oxide)-based, or it may be, for example, castor oil. In a particularly preferred embodiment, the triol is castor oil.

In a preferred embodiment, the at least one polyol comprises a mixture of a polyether diol and castor oil.

In another preferred embodiment, the at least one polyol comprises a mixture of polyether diol having molecular weight of less than 600 Da and castor oil.

In another preferred embodiment, the at least one polyol comprises a mixture of a poly(propylene oxide)-based diol and castor oil.

In another preferred embodiment, the at least one polyol comprises a mixture of a poly(propylene oxide)-based diol having a molecular weight of less than 600 Da and castor oil.

In a preferred embodiment, Component B comprises 2-15 wt %, more preferably 4-10 wt %, more particularly preferably 5-7 wt % of a diol, based on the total weight of Component B.

In another preferred embodiment, Component B comprises 5-20 wt %, more preferably 7-15 wt %, particularly preferably 8-11 wt % of a triol, based on the total weight of Component B.

In another preferred embodiment, Component B comprises 2-15 wt %, more preferably 4-10 wt %, more particularly preferably 5-7 wt % of a diol having molecular weight of less than 600 Da, based on the total weight of Component B.

In another preferred embodiment, Component B comprises 5-20 wt %, more preferably 7-15 wt %, particularly preferably 8-11 wt % of a triol having molecular weight of less than 1,000 Da, based on the total weight of Component B.

In another preferred embodiment, Component B comprises 2-15 wt %, more preferably 4-10 wt %, more particularly preferably 5-7 wt % of a diol having molecular weight of less than 600 Da, based on the total weight of Component B, and 5-20 wt %, more preferably 7-15 wt %, particularly preferably 8-11 wt % of a triol having molecular weight of less than 1,000 Da, based on the total weight of Component B.

In another preferred embodiment, Component B comprises 4-10 wt %, more particularly preferably 5-7 wt % of a poly(propylene oxide) diol having molecular weight of less than 600 Da, based on the total weight of Component B.

In another preferred embodiment, Component B comprises 5-20 wt %, more preferably 7-15 wt %, particularly preferably 8-11 wt % of castor oil, based on the total weight of Component B.

In another preferred embodiment, Component B comprises 4-10 wt %, more particularly preferably 5-7 wt % of a poly(propylene oxide) diol having molecular weight of less than 600 Da, based on the total weight of Component B, and 5-20 wt %, more preferably 7-15 wt %, particularly preferably 8-11 wt % of castor oil, based on the total weight of Component B.

Component B additionally comprises a catalyst that is capable of catalyzing the reaction of isocyanate groups with OH groups.

Examples of such catalysts include tertiary amine catalysts, organometallic catalysts, such as bismuth catalysts, alkyl tin carboxylates, oxides and tin mercaptides.

Specific examples of tertiary amine catalysts include N-methyl morpholine, N-methyl imidazole, triethylenediamine, bis-(2-dimethylaminoethyl)-ether, 1,4-diazabicyclo[2.2.2]octane (DABCO), dimethylcyclohexylamine, dimethylethanolamine, 2,2-dimorpholinyl-diethylether (DMDEE), N,N,N-dimethylaminopropyl hexahydrotriazine, dimethyltetrahydropyrimidine, tetramethylethylenediamine, dimethylcyclohexylamine, 2,2-N,N benzyldimethylamine, dimethylethanol amine, dimethylaminopropyl amine, Penta-dimethyl diethylene triamine, N,N,N′,N′-tetramethyl-1,6-hexanediamine, N,N′,N′-trimethylaminoethylpiperazine, 1,1′-[[3-(dimethylamino)propyl]imino]bispropan-2-ol, 1,3,5-tris[3-(dimethylamino)propyl]hexahydro-1,3,5-triazine, N—N-dimethyldipropylene triamine, N,N,N′-trimethylaminoethylethanolamine, with DMDEE being particularly preferred.

If an organometallic catalyst is used, it is any organometallic catalyst capable of catalyzing the reaction of isocyanate with a functional group having at least one reactive hydrogen. Examples include bismuth catalysts, metal carboxylates such as tin carboxylate and zinc carboxylate. Metal alkanoates include stannous octoate, bismuth octoate or bismuth neodecanoate. Preferably the at least one organometallic catalyst is a bismuth catalyst or an organotin catalyst. Examples include dibutyltin dilaurate, dimethyl tin dineodecanoate, dimethyltin mercaptide, dimethyltin carboxylate, dimethyltin dioleate, dimethyltin dithioglycolate, dibutyltin mercaptide, dibutyltin bis(2-ethylhexyl thioglycolate), dibutyltin sulfide, dioctyltin dithioglycolate, dioctyltin mercaptide, dioctyltin dioctoate, dioctyltin dineodecanoate, dioctyltin dilaurate. In a preferred embodiment, the catalyst is a tin catalyst, particularly preferably dioctyltin mercaptide, and/or dimethyltin dithioglycolate. In a particularly preferred embodiment, the catalyst is dioctyltin mercaptide.

The catalyst is preferably used at 0.0005 to 0.002 wt %, more preferably 0.00075 to 0.0015 wt %, based on the total weight of Component B.

In a preferred embodiment, the catalyst is dioctyl tin mercaptide, used at 0.0005 to 0.002 wt %, more preferably 0.00075 to 0.0015 wt %, based on the total weight of Component B.

Component B may additionally comprise a silane comprising a hydrolysable silyl alkoxy group covalently bonded to a C₈₋₂₀ alkyl group. Examples of such silanes include trialkoxy-C₈₋₂₀-alkyl silanes, in particular trimethoxy-C₈₋₂₀-alkyl silanes and triethoxy-C₈₋₂₀-alkyl silanes, with trimethoxy-C₈₋₂₀-alkyl silanes being particularly preferred. In a preferred embodiment, Component B comprises hexadecyl-trimethoxy silane.

If used, the silane is preferably present in Component B at 0.25-3 wt %, more preferably 0.5-2 wt %, particularly preferably 0.75-1.2 wt %, based on the total weight of Component B.

In a preferred embodiment, Component B comprises hexadecyl-trimethoxy silane at 0.25-3 wt %, more preferably 0.5-2 wt %, particularly preferably 0.75-1.2 wt %, based on the total weight of Component B.

Component B may additionally comprise ATH and alumina, as will be described in more detail below.

Component B may additionally comprise fibrous fillers, such as wollastonite. If used, wollastonite is preferably present at 0.75-5 wt %, more preferably 1-4 wt %, more particularly preferably 2.8-3.2 wt %, based on the total weight of Component B.

Component B may additionally comprise fumed silica. If used, fumed silica is preferably present at 0.75-2 wt %, more preferably 1-2 wt %, based on the total weight of Component A.

Component B may additionally comprise a polyester diol. Examples include polycaprolactone, particularly polycaprolactone having a mean molecular weight (Mₙ) of 1,500-2,500 Da, more preferably 2,000 Da.

If used, the polyester diol is used at 0.1-0.4 wt %, more preferably 0.15-0.25 wt %, based on the total weight of Component B.

Component B is typically formulated by drying the solid ingredients, such as ATH and alumina, wollastonite, fumed silica at elevated temperature under vacuum. Preferably drying is carried out until the moisture content is 300 ppm or less. The at least one polyol, catalyst and silane, if used, are added to the dry ingredients and mixed to homogeneity under reduced pressure, and Component B is then stored in a moisture-proof container.

### Filler

Component A and/or Component B comprise the following fillers: aluminium trihydroxide (ATH) and alumina.

The ATH preferably has a multimodal particle size distribution. The expression multimodal particle size distribution means that if the particle sizes are plotted with particle size on the x-axis and vol % on the y-axis, at least two main peaks are observed.

In a preferred embodiment, the aluminium trihydroxide is bimodal.

The particle size distribution of the aluminium trihydroxide is typically measured using laser diffraction, using water containing sodium pyrophosphate as a suspending agent.

In a preferred embodiment, the aluminium trihydroxide has the following particle size distribution:
D₁₀=0.5 μm
D₅₀=8 μm
D₉₀=80 μm.

The ATH is present in Component A and/or Component B such that when the two components are mixed (preferably in a 0.8:1 to 1.2:1, more preferably 1:1 volumetric ratio) to form an adhesive mixture, the concentration of ATH in the adhesive mixture is least 40 wt % based on the total weight of the adhesive mixture. In a preferred embodiment, the concentration of ATH in the adhesive mixture is from 40-65 wt %, more preferably 43-60 wt %, particularly preferably 44-57 wt %, based on the total weight of the adhesive mixture.

The ATH may be present in Component A, Component B or both. Preferably, both Component A and Component B comprise ATH.

In a preferred embodiment, the concentration of ATH in Component A is from 40-65 wt %, more preferably 43-60 wt %, particularly preferably 44-57 wt %, based on the total weight of the Component A.

In a preferred embodiment, the concentration of ATH in Component B is from 40-65 wt %, more preferably 43-60 wt %, particularly preferably 44-57 wt %, based on the total weight of the Component B.

In a preferred embodiment, the concentration of ATH in Component A is from 40-65 wt %, more preferably 43-60 wt %, particularly preferably 44-57 wt %, based on the total weight of the Component A, and the concentration of ATH in Component B is from 40-65 wt %, more preferably 43-60 wt %, particularly preferably 44-57 wt %, based on the total weight of the Component B.

The alumina preferably has spherical shaped particles. For the purposes of this description, “spherical” means particles having an aspect ratio of 0.8-1.2, more preferably 0.9-1.1.

The alumina preferably has a multimodal particle size distribution. The expression multimodal particle size distribution means that if the particle sizes are plotted with particle size on the x-axis and vol % on the y-axis, at least two main peaks are observed.

Preferably the alumina is bimodal.

The particle size distribution of the alumina is typically measured using laser diffraction, using water containing sodium pyrophosphate as a suspending agent.

In a preferred embodiment, the alumina has the following particle size distribution:
D₁₀=1-5 μm, preferably 3 μm
D₅₀=45-50 μm, preferably 46.5 μm
D₉₀=80-100 μm, preferably 90 μm.

In a preferred embodiment, the alumina has the following particle size distribution:

| | Particle range | | | | | |
|---|---|---|---|---|---|---|
| | <1 μm | 1-10 μm | 10-20 μm | 20-45 μm | 45-100 μm | >100 μm |
| Vol | 5.875 | 26.875 | 5.925 | 8.825 | 47.5 | 5 |
| % | | | | | | |

In a preferred embodiment, the alumina is a mixture of alumina having a D₅₀ of 5.7 μm and alumina having a D₅₀ of 72 μm. Particularly preferred is a mixture of 0.4:1 to 0.8:1, more preferably 0.5:1 to 0.7:1, particularly preferably 0.6:1 (wt:wt) of alumina having a D₅₀ of 5.7 μm and alumina having a D₅₀ of 72 μm.

The alumina is present in Component A and/or Component B such that when the two components are mixed (preferably in a 0.8:1 to 1.2:1, more preferably 1:1 volumetric ratio) to form an adhesive mixture, the concentration of alumina in the adhesive mixture is least 15 wt % based on the total weight of the adhesive mixture. In a preferred embodiment, the concentration of alumina in the adhesive mixture is from 15-40 wt %, more preferably 16-35 wt %, particularly preferably 17-34 wt %, based on the total weight of the adhesive mixture.

The alumina may be present in Component A, Component B or both. Preferably, both Component A and Component B comprise alumina.

In a preferred embodiment, the concentration of alumina in Component A is from 15-40 wt %, more preferably 16-35 wt %, particularly preferably 17-34 wt %, based on the total weight of the Component A.

In a preferred embodiment, the concentration of alumina in Component B is from 15-40 wt %, more preferably 16-35 wt %, particularly preferably 17-34 wt %, based on the total weight of the Component B.

In a preferred embodiment, the concentration of alumina in Component A is from 15-40 wt %, more preferably 16-35 wt %, particularly preferably 17-34 wt %, based on the total weight of the Component A, and the concentration of alumina in Component B is from 15-40 wt %, more preferably 16-35 wt %, particularly preferably 17-34 wt %, based on the total weight of the Component B.

In a preferred embodiment, the ATH and the alumina are multimodal.

In a preferred embodiment, the ATH and the alumina are bimodal.

In a preferred embodiment, the ATH and the alumina are multimodal, and the alumina has a spherical particle shape.

In a preferred embodiment, the ATH and the alumina are bimodal, and the alumina has a spherical particle shape.

In a preferred embodiment, the ATH has the following particle size distribution:
D₁₀=0.5 μm
D₅₀=8 μm
D₉₀=80 μm,
   and the alumina has the following particle size distribution:
D₁₀=1-5 μm, preferably 3 μm
D₅₀=45-50 μm, preferably 46.5 μm
D₉₀=80-100 μm, preferably 90 μm.

In a preferred embodiment, the ATH is present in Component A and/or Component B such that when the two components are mixed (preferably in a 0.8:1 to 1.2:1, more preferably 1:1 volumetric ratio) to form an adhesive mixture, the concentration of ATH in the adhesive mixture is from 40-65 wt %, more preferably 43-60 wt %, particularly preferably 44-57 wt %, based on the total weight of the adhesive mixture, and the concentration of alumina in the adhesive mixture is from 15-40 wt %, more preferably 16-35 wt %, particularly preferably 17-34 wt %, based on the total weight of the adhesive mixture.

In a preferred embodiment, ATH and alumina are both present in Component A and Component B.

In a preferred embodiment, the concentration of ATH in Component A is from 40-65 wt %, more preferably 43-60 wt %, particularly preferably 44-57 wt %, based on the total weight of the Component A, and the concentration of alumina in Component A is from 15-40 wt %, more preferably 16-35 wt %, particularly preferably 17-34 wt %, based on the total weight of the Component A.

In a preferred embodiment, the concentration of ATH in Component B is from 40-65 wt %, more preferably 43-60 wt %, particularly preferably 44-57 wt %, based on the total weight of the Component B, and the concentration of alumina in Component B is from 15-40 wt %, more preferably 16-35 wt %, particularly preferably 17-34 wt %, based on the total weight of the Component B.

In a preferred embodiment, the concentration of ATH in Component A is from 40-65 wt %, more preferably 43-60 wt %, particularly preferably 44-57 wt %, based on the total weight of the Component A, and the concentration of ATH in Component B is from 40-65 wt %, more preferably 43-60 wt %, particularly preferably 44-57 wt %, based on the total weight of the Component B, and the concentration of alumina in Component A is from 15-40 wt %, more preferably 16-35 wt %, particularly preferably 17-34 wt %, based on the total weight of the Component A, and the concentration of alumina in Component B is from 15-40 wt %, more preferably 16-35 wt %, particularly preferably 17-34 wt %, based on the total weight of the Component B.

### Method of Manufacture

The adhesive compositions of the invention are made by mixing the ingredients of each Component separately, preferably under inert and dry conditions and/or under vacuum, until a homogenous mixture is obtained. Once the Components are prepared, they are stored in separate containers until use.

### Method of Use

In one aspect, the invention provides a method for adhering two or more substrates, comprising the steps:
(1) providing an adhesive comprising:
(A) Component A:
(ai) an NCO-terminated prepolymer made by reacting at least one polyether mono-ol of molecular weight (Mₙ) greater than 800 Da with at least one polyisocyanate;
(B) Component B:
(bi) at least one polyol; and
(bii) a catalyst capable of catalyzing the reaction of OH groups with NCO groups;
wherein Component A and/or Component B comprise aluminium trihydroxide (ATH) in an amount such that when Component A and B are mixed to produce an adhesive mixture, the content of ATH in the adhesive mixture is at least 40 wt % based on the total weight of the adhesive mixture, and wherein Component A and/or Component B comprise alumina in an amount such that when Component A and B are mixed to produce an adhesive mixture, the content of alumina in the adhesive mixture is at least 15 wt % based on the total weight of the adhesive mixture;
(2) mixing Component A and Component B to produce an adhesive mixture;
(3) applying the adhesive mixture to a first substrate;
(4) bringing the first substrate into adhesive contact with a second substrate;
(5) allowing the adhesive mixture to cure.

The ingredients for Components A and B, useful for the method of the invention, are as described for the adhesive.

Mixing of Component A and Component B is carried out by any method that can achieve a homogenous mixture fairly quickly. Typically, mixing is achieved by dispensing both components simultaneously into a mixing container or passage. Mixing of Component A and Component B may be in any desired proportion, but is typically done using a volumetric ratio A:B of 0.8-1.2, more preferably 1.

Applying the adhesive mixture to a substrate is typically performed using a suitable application gun and a static mixer. The adhesive is filled in cartridges which can ensure the suitable mixing ratio. The cartridges are placed in the application gun and a suitable static mixer is mounted. Then the adhesive is pressed through the static mixer on to the surface to be bonded.

Curing is typically done at ambient temperature (e.g. 23° C.), and humidity (e.g. 50% relative humidity). Full cure with the adhesives of the invention usually develops in 7-10 days.

The substrates are not particularly limited, and include metals and plastics. The adhesives of the invention are particularly suited for adhering e-coated steel, PET films, Aluminized plastic films, Aluminium.

Preferred applications include thermal conductive material, used in any application where a thermal conductive material is needed, with main application in automotive industry for the thermal management of the EV battery; especially for the bonding of the modules or cell to cooling plate.

### Effect of the Invention

The cured adhesives of the invention (7 days, 23° C., 50% RH) preferably show a thermal conductivity of 1.5 W/mK or greater, more preferably 1.6 W/mK or greater, more particularly preferably 1.8 W/mK or greater. Thermal conductivity is measured according to ASTM 5470, as described in the Examples.

The cured adhesives of the invention (7 days, 23° C., 50% RH) preferably show a lap shear strength of 1.5 MPa or greater, when measured according to DIN EN 1465, with a bonded area: 250 mm² (10×25 mm), adhesive layer thickness of 1 mm, using e-coated steel for both substrates.

The adhesive mixture resulting from mixing Component A and Component B (preferably in a 0.8:1 to 1.2:1, more preferably 1:1 volumetric ratio) preferably has a working time of greater than 35 minutes, more preferably greater than 40 minutes, particularly preferably greater than 50 minutes. Working time is the time to develop a compression force of 150 KPa, when pressed into a 1 mm gap at a pressing rate of 62.5 mm/min by a parallel plate with a diameter of 50 mm.

The adhesive mixture resulting from mixing Component A and Component B (preferably in a 0.8:1 to 1.2:1, more preferably 1:1 volumetric ratio) preferably has a compression force immediately after mixing of less than 80 KPa, more preferably less than 78 KPa, when pressed into a 1 mm gap at a pressing rate of 62.5 mm/min by a parallel plate with a diameter of 50 mm.

The adhesive mixture resulting from mixing Component A and Component B (preferably in a 0.8:1 to 1.2:1, more preferably 1:1 volumetric ratio) preferably has a compression force 30 minutes after mixing of less than 130 KPa, more preferably less than 128 KPa, when pressed into a 1 mm gap at a pressing rate of 62.5 mm/min by a parallel plate with a diameter of 50 mm.

The adhesive mixture resulting from mixing Component A and Component B (preferably in a 0.8:1 to 1.2:1, more preferably 1:1 volumetric ratio) preferably has a compression force 60 minutes after mixing of less than 160 KPa, more preferably less than 155 KPa, when pressed into a 1 mm gap at a pressing rate of 62.5 mm/min by a parallel plate with a diameter of 50 mm.

### Particularly Preferred Embodiments

The following are particularly preferred embodiments of the adhesive compositions of the invention:
1. A two-component thermally-conductive polyurethane adhesive, comprising:
   (A) Component A:
   (ai) an NCO-terminated prepolymer made by reacting at least one polyether mono-ol of molecular weight (Mₙ) greater than 800 Da with at least one polyisocyanate selected from aliphatic polyisocyanates and mixtures of 2,4′-methylene-bis-(phenyl isocyanate) (MDI) and 4,4′-MDI;
   (B) Component B:
   (bi) at least one polyol; and
   (bii) a catalyst capable of catalyzing the reaction of OH groups with NCO groups;
   wherein Component A and/or Component B comprise aluminium trihydroxide (ATH) in an amount such that when Component A and B are mixed to produce an adhesive mixture, the content of ATH in the adhesive mixture is at least 40 wt % based on the total weight of the adhesive mixture, and wherein Component A and/or Component B comprise alumina in an amount such that when Component A and B are mixed to produce an adhesive mixture, the content of alumina in the adhesive mixture is at least 15 wt % based on the total weight of the adhesive mixture.
2. A kit for producing a thermally-conductive polyurethane adhesive, comprising:
   (A) Component A:
   (ai) an NCO-terminated prepolymer made by reacting at least one polyether mono-ol of molecular weight (Mₙ) greater than 800 Da with at least one polyisocyanate selected from aliphatic polyisocyanates and mixtures of 2,4′-methylene-bis-(phenyl isocyanate) (MDI) and 4,4′-MDI;
   (B) Component B:
   (bi) at least one polyol; and
   (bii) a catalyst capable of catalyzing the reaction of OH groups with NCO groups;
   wherein Component A and/or Component B comprise aluminium trihydroxide (ATH) in an amount such that when Component A and B are mixed to produce an adhesive mixture, the content of ATH in the adhesive mixture is at least 40 wt % based on the total weight of the adhesive mixture, and wherein Component A and/or Component B comprise alumina in an amount such that when Component A and B are mixed to produce an adhesive mixture, the content of alumina in the adhesive mixture is at least 15 wt % based on the total weight of the adhesive mixture.
3. A method for adhering two or more substrates, comprising the steps:
   (1) providing an adhesive comprising:
   (A) Component A:
   (ai) an NCO-terminated prepolymer made by reacting at least one polyether mono-ol of molecular weight (Mₙ) greater than 800 Da with at least one polyisocyanate selected from aliphatic polyisocyanates and mixtures of 2,4′-methylene-bis-(phenyl isocyanate) (MDI) and 4,4′-MDI;
   (B) Component B:
   (bi) at least one polyol; and
   (bii) a catalyst capable of catalyzing the reaction of OH groups with NCO groups;
   wherein Component A and/or Component B comprise aluminium trihydroxide (ATH) in an amount such that when Component A and B are mixed to produce an adhesive mixture, the content of ATH in the adhesive mixture is at least 40 wt % based on the total weight of the adhesive mixture, and wherein Component A and/or Component B comprise alumina in an amount such that when Component A and B are mixed to produce an adhesive mixture, the content of alumina in the adhesive mixture is at least 15 wt % based on the total weight of the adhesive mixture;
   (2) mixing Component A and Component B to produce an adhesive mixture;
   (3) applying the adhesive mixture to a first substrate;
   (4) bringing the first substrate into adhesive contact with a second substrate;
   (5) allowing the adhesive mixture to cure.
4. An adhered assembly, comprising:
   (1) a first substrate;
   (2) a second substrate adhered to the first substrate;
   wherein the first substrate and the second substrate are adhered one to the other by an adhesive made by mixing together the following Component A and Component B:
   (A) Component A:
   (ai) an NCO-terminated prepolymer made by reacting at least one polyether mono-ol of molecular weight (Mₙ) greater than 800 Da with at least one polyisocyanate selected from aliphatic polyisocyanates and mixtures of 2,4′-methylene-bis-(phenyl isocyanate) (MDI) and 4,4′-MDI;
   (B) Component B:
   (bi) at least one polyol; and
   (bii) a catalyst capable of catalyzing the reaction of OH groups with NCO groups;
   wherein Component A and/or Component B comprise aluminium trihydroxide (ATH) in an amount such that when Component A and B are mixed to produce an adhesive mixture, the content of ATH in the adhesive mixture is at least 40 wt % based on the total weight of the adhesive mixture, and wherein Component A and/or Component B comprise alumina in an amount such that when Component A and B are mixed to produce an adhesive mixture, the content of alumina in the adhesive mixture is at least 15 wt % based on the total weight of the adhesive mixture.
5. Any one preceding embodiment, wherein the polyether mono-ol is selected from monoethers of poly(C₂₋₄-alkylene oxide) diols, and monoesters of poly(C₂₋₄-alkylene oxide) diols.
6. Any one preceding embodiment, wherein the polyether mono-ol is selected from monoethers of poly(ethylene oxide) diols, monoethers of poly(propylene oxide) diols, monoethers of poly(butylene oxide) diols, and mixtures of these.
7. Any one preceding embodiment, wherein the polyether mono-ol is selected from monoethers of poly(propylene oxide) diols.
8. Any one preceding embodiment, wherein the polyether mono-ol is selected from terminal methyl, ethyl and propyl monoethers.
9. Any one preceding embodiment, wherein the polyether mono-ol is selected from terminal methyl monoethers.
10. Any one preceding embodiment, wherein the polyether mono-ol is selected from monomethyl ethers of poly(propylene oxide) diols.
11. Any one preceding embodiment, wherein the polyether mono-ol has a molecular weight (Mn) greater than 800 Da, and less than 2,000 Da, more preferably less than 1,500 Da, more particularly preferably 1,000 Da.
12. Any one preceding embodiment, wherein the polyether mono-ol is a monomethyl ether of poly(propylene oxide) diol, in particular poly(propylene glycol) having a molecular weight (Mₙ) of 1,000 Da.
13. Any one preceding embodiment, wherein the polyisocyanate is aliphatic.
14. Any one preceding embodiment, wherein the polyisocyanate is selected from isophorone diisocyanate (IPDI), Dicyclohexyl methane diisocyanate (HMDI), hexamethylene diisocyanate (HDI), and mixtures of these.
15. Any one of embodiments 1-12, wherein the polyisocyanate is a mixture of 2,4′-MDI and 4,4′-MDI.
16. Any one of embodiments 1-12, wherein the polyisocyanate is a mixture of 2,4′-MDI and 4,4′-MDI in which the weight ratio of 2,4′-MDI to 4,4′-MDI is 0.667-1.5, more preferably 0.8-1.5, more particularly preferably 1-1.5.
17. Any one of embodiments 1-12, wherein the polyisocyanate used to make the prepolymer is a mixture of 4,4′-MDI and 2,4-MDI, with a 1:1 weight ratio of 4,4′-MDI and 2,4-MDI.
18. Any one preceding embodiment, wherein the at least one polyisocyanate is used in a stoichiometric excess of 2-15-fold with respect to the mono-ol, more preferably 8-12-fold with respect to the mono-ol, particularly preferably 10-fold with respect to the mono-ol.
19. Any one preceding embodiment, wherein the prepolymer is made by reacting poly(propylene glycol) mono-methyl ether with a mixture of 2,4′-MDI and 4,4′-MDI.
20. Any one preceding embodiment, wherein the prepolymer is made by reacting poly(propylene glycol) mono-methyl ether of molecular weight (Mₙ) 800-1,500 Da with a mixture of 2,4′-MDI and 4,4′-MDI.
21. Any one preceding embodiment, wherein the at least one polyether mono-ol is used in Component A at 5-20 wt %, more preferably 6-10 wt %, particularly preferably 8-9 wt %, based on the total weight of Component A.
22. Any one preceding embodiment, wherein the at least one polyisocyanate is used in Component A at 5-20 wt %, more preferably 6-15 wt %, more particular preferably 10-11 wt %, based on the total weight of Component A.
23. Any one preceding embodiment, wherein the NCO-terminated prepolymer comprises 30-55 wt % polyether mono-ol, more preferably 35-50 wt %, particularly preferably 42-45 wt %, based on the total weight of the prepolymer.
24. Any one preceding embodiment, wherein the NCO-terminated prepolymer comprises 40-65 wt % diisocyanate, more preferably 45-60 wt %, particularly preferably 50-58 wt %, based on the total weight of the prepolymer.
25. Any one preceding embodiment, wherein the prepolymer comprises 30-55 wt % polyether mono-ol, more preferably 35-50 wt %, particularly preferably 42-45 wt %, based on the total weight of the prepolymer and 40-65 wt % diisocyanate, more preferably 45-60 wt %, particularly preferably 50-58 wt %, based on the total weight of the prepolymer.
26. Any one preceding embodiment, wherein the prepolymer is used in Component A at 15-30 wt %, more preferably 16-25 wt %, more particularly preferably 18-20 wt %, based on the total weight of Component A.
27. Any one preceding embodiment, wherein Component A and/or Component B additionally comprises a silane comprising a hydrolysable silyl alkoxy group covalently bonded to a C₈₋₂₀ alkyl group.
28. Any one preceding embodiment, wherein Component A and/or Component B comprises hexadecyl-trimethoxy silane.
29. Any one preceding embodiment, wherein Component A and/or Component B comprises silane at 0.25-3 wt %, more preferably 0.5-2 wt %, particularly preferably 0.75-1.2 wt %, based on the total weight of Component A or Component B.
30. Any one preceding embodiment, wherein Component A and/or Component B additionally comprises fibrous fillers, such as wollastonite.
31. Any one preceding embodiment, wherein Component A and/or Component B comprises wollastonite at 0.5-4 wt %, more preferably 1-3 wt %, more particularly preferably 1.7-2.2 wt %, based on the total weight of Component A or Component B.
32. Any one preceding embodiment, wherein the at least one polyol comprises polyols having molecular weights of less than 1,500 Da, more preferably less than or equal to 1,000 Da.
33. Any one preceding embodiment, wherein the at least one polyol comprises diols, triols and mixtures of these.
34. Any one preceding embodiment, wherein the at least one polyol comprises at least one diol, in particular a polyether-based diol.
35. Any one preceding embodiment, wherein the at least one polyol comprises a poly(propylene oxide)-based diol.
36. Any one preceding embodiment, wherein the at least one polyol comprises a mixture of diols and triols.
37. Any one preceding embodiment, wherein the at least one polyol comprises diols, triols and mixtures of these, all having molecular weights of less than 1,500 Da, more preferably less than 1,000 Da.
38. Any one preceding embodiment, wherein the at least one polyol comprises a mixture of diols and triols, having molecular weights of less than 1,500 Da, more preferably less than 1,000 Da.
39. Any one preceding embodiment, wherein the at least one polyol comprises a polyether polyol.
40. Any one preceding embodiment, wherein the at least one polyol comprises a polyether polyol selected from poly(C₂₋₄-alkylene oxide)-based polyols, particularly poly(ethylene oxide)-based, poly(propylene oxide)-based, poly(butylene oxide)-based polyols, and mixtures of these.
41. Any one preceding embodiment, wherein the at least one polyol is selected from poly(propylene oxide)-based polyols.
42. Any one preceding embodiment, wherein the at least one polyol comprises a triol.
43. Any one preceding embodiment, wherein the at least one polyol comprises a triol selected from poly(C₂₋₄-alkylene oxide)-based triols.
44. Any one preceding embodiment, wherein the at least one polyol comprises a poly(propylene oxide)-based triol.
45. Any one preceding embodiment, wherein the at least one polyol comprises castor oil.
46. Any one preceding embodiment, wherein the at least one polyol comprises a mixture of a polyether diol and castor oil.
47. Any one preceding embodiment, wherein the at least one polyol comprises a mixture of polyether diol having molecular weight of less than 600 Da and castor oil.
48. Any one preceding embodiment, wherein the at least one polyol comprises a mixture of a poly(propylene oxide)-based diol and castor oil.
49. Any one preceding embodiment, wherein the at least one polyol comprises a mixture of a poly(propylene oxide)-based diol having a molecular weight of less than 600 Da and castor oil.
50. Any one preceding embodiment, wherein Component B comprises 2-15 wt %, more preferably 4-10 wt %, more particularly preferably 5-7 wt % of a diol, based on the total weight of Component B.
51. Any one preceding embodiment, wherein Component B comprises 5-20 wt %, more preferably 7-15 wt %, particularly preferably 8-11 wt % of a triol, based on the total weight of Component B.
52. Any one preceding embodiment, wherein Component B comprises 2-15 wt %, more preferably 4-10 wt %, more particularly preferably 5-7 wt % of a diol having molecular weight of less than 600 Da, based on the total weight of Component B.
53. Any one preceding embodiment, wherein Component B comprises 5-20 wt %, more preferably 7-15 wt %, particularly preferably 8-11 wt % of a triol having molecular weight of less than 1,000 Da, based on the total weight of Component B.
54. Any one preceding embodiment, wherein Component B comprises 2-15 wt %, more preferably 4-10 wt %, more particularly preferably 5-7 wt % of a diol having molecular weight of less than 600 Da, based on the total weight of Component B, and 5-20 wt %, more preferably 7-15 wt %, particularly preferably 8-11 wt % of a triol having molecular weight of less than 1,000 Da, based on the total weight of Component B.
55. Any one preceding embodiment, wherein Component B comprises 4-10 wt %, more particularly preferably 5-7 wt % of a poly(propylene oxide) diol having molecular weight of less than 600 Da, based on the total weight of Component B.
56. Any one preceding embodiment, wherein Component B comprises 5-20 wt %, more preferably 7-15 wt %, particularly preferably 8-11 wt % of castor oil, based on the total weight of Component B.
57. Any one preceding embodiment, wherein Component B comprises 4-10 wt %, more particularly preferably 5-7 wt % of a poly(propylene oxide) diol having molecular weight of less than 600 Da, based on the total weight of Component B, and 5-20 wt %, more preferably 7-15 wt %, particularly preferably 8-11 wt % of castor oil, based on the total weight of Component B.
58. Any one preceding embodiment, wherein the catalyst is selected from tertiary amine catalysts and organometallic catalysts.
59. Any one preceding embodiment, wherein the catalyst is selected from alkyl tin carboxylates, oxides and tin mercaptides.
60. Any one preceding embodiment, wherein the catalyst is dioctyltin mercaptide.
61. Any one preceding embodiment, wherein the catalyst is used at 0.0005 to 0.002 wt %, more preferably 0.00075 to 0.0015 wt %, based on the total weight of Component B.
62. Any one preceding embodiment, wherein the catalyst is dioctyl tin mercaptide, used at 0.0005 to 0.002 wt %, more preferably 0.00075 to 0.0015 wt %, based on the total weight of Component B.
63. Any one preceding embodiment, wherein Component B additionally comprises a polyester diol.
64. Any one preceding embodiment, wherein Component B additionally comprises a polycaprolactone.
65. Any one preceding embodiment, wherein Component B additionally comprises a polycaprolactone having a mean molecular weight (Mₙ) of 1,500-2,500 Da, more preferably 2,000 Da.
66. Any one preceding embodiment, wherein Component B additionally comprises a polyester diol is used at 0.1-0.4 wt %, more preferably 0.15-0.25 wt %, based on the total weight of Component B.
67. Any one preceding embodiment, wherein the ATH has a multimodal particle size distribution.
68. Any one preceding embodiment, wherein the ATH has a bimodal particle size distribution.
69. Any one preceding embodiment, wherein the aluminium trihydroxide has the following particle size distribution:
   D₁₀=0.5 μm
   D₅₀=8 μm
   D₉₀=80 μm.
70. Any one preceding embodiment, wherein ATH is present in Component A and/or Component B such that when the two components are mixed (preferably in a 0.8:1 to 1.2:1, more preferably 1:1 volumetric ratio) to form an adhesive mixture, the concentration of ATH in the adhesive mixture is from 40-65 wt %, more preferably 43-60 wt %, particularly preferably 44-57 wt %, based on the total weight of the adhesive mixture.
71. Any one preceding embodiment, wherein ATH is present in Component A, Component B or both.
72. Any one preceding embodiment, wherein both Component A and Component B comprise ATH.
73. Any one preceding embodiment, wherein the concentration of ATH in Component A is from 40-65 wt %, more preferably 43-60 wt %, particularly preferably 44-57 wt %, based on the total weight of the Component A.
74. Any one preceding embodiment, wherein the concentration of ATH in Component B is from 40-65 wt %, more preferably 43-60 wt %, particularly preferably 44-57 wt %, based on the total weight of the Component B.
75. Any one preceding embodiment, wherein the concentration of ATH in Component A is from 40-65 wt %, more preferably 43-60 wt %, particularly preferably 44-57 wt %, based on the total weight of the Component A, and the concentration of ATH in Component B is from 40-65 wt %, more preferably 43-60 wt %, particularly preferably 44-57 wt %, based on the total weight of the Component B.
76. Any one preceding embodiment, wherein the alumina has spherical shaped particles.
77. Any one preceding embodiment, wherein the alumina particles have an aspect ratio of 0.8-1.2, more preferably 0.9-1.1.
78. Any one preceding embodiment, wherein the alumina has a multimodal particle size distribution.
79. Any one preceding embodiment, wherein the alumina is bimodal.
80. Any one preceding embodiment, wherein the alumina has the following particle size distribution:
   D₁₀=1-5 μm, preferably 3 μm
   D₅₀=45-50 μm, preferably 46.5 μm
   D₉₀=80-100 μm, preferably 90 μm
81. Any one preceding embodiment, wherein the alumina has the following particle size distribution:

| | Particle range | | | | | |
|---|---|---|---|---|---|---|
| | <1 μm | 1-10 μm | 10-20 μm | 20-45 μm | 45-100 μm | >100 μm |
| Vol | 5.875 | 26.875 | 5.925 | 8.825 | 47.5 | 5 |
| % | | | | | | |

82. Any one preceding embodiment, wherein the alumina is a mixture of alumina having a D₅₀ of 5.7 μm and alumina having a D₅₀ of 72 μm.
83. Any one preceding embodiment, wherein the alumina is a mixture of 0.4:1 to 0.8:1, more preferably 0.5:1 to 0.7:1, particularly preferably 0.6:1 (wt:wt) of alumina having a D₅₀ of 5.7 μm and alumina having a D₅₀ of 72 μm.
84. Any one preceding embodiment, wherein the alumina is present in Component A and/or Component B such that when the two components are mixed (preferably in a 0.8:1 to 1.2:1, more preferably 1:1 volumetric ratio) to form an adhesive mixture, the concentration of alumina in the adhesive mixture is from 15-40 wt %, more preferably 16-35 wt %, particularly preferably 17-34 wt %, based on the total weight of the adhesive mixture.
85. Any one preceding embodiment, wherein the alumina is present in Component A, Component B or both.
86. Any one preceding embodiment, wherein both Component A and Component B comprise alumina.
87. Any one preceding embodiment, wherein the concentration of alumina in Component A and/or B is from 15-40 wt %, more preferably 16-35 wt %, particularly preferably 17-34 wt %, based on the total weight of the Component A or B.
88. Any one preceding embodiment, wherein the ATH and the alumina are multimodal.
89. Any one preceding embodiment, wherein the ATH and the alumina are bimodal.
90. Any one preceding embodiment, wherein the ATH and the alumina are multimodal, and the alumina has a spherical particle shape.
91. Any one preceding embodiment, wherein the ATH and the alumina are multimodal, and the alumina has an aspect ratio of 0.8-1.2, more preferably 0.9-1.1.
92. Any one preceding embodiment, wherein the ATH and the alumina are bimodal, and the alumina has a spherical particle shape.
93. Any one preceding embodiment, wherein the ATH and the alumina are bimodal, and the alumina has an aspect ratio of 0.8-1.2, more preferably 0.9-1.1.
94. Any one preceding embodiment, wherein the ATH has the following particle size distribution:
   D₁₀=0.5 μm
   D₅₀=8 μm
   D₉₀=80 μm,
   and the alumina has the following particle size distribution:
   D₁₀=1-5 μm, preferably 3 μm
   D₅₀=45-50 μm, preferably 46.5 μm
   D₉₀=80-100 μm, preferably 90 μm
95. Any one preceding embodiment, wherein the ATH is present in Component A and/or Component B such that when the two components are mixed (preferably in a 0.8:1 to 1.2:1, more preferably 1:1 volumetric ratio) to form an adhesive mixture, the concentration of ATH in the adhesive mixture is from 40-65 wt %, more preferably 43-60 wt %, particularly preferably 44-57 wt %, based on the total weight of the adhesive mixture, and the concentration of alumina in the adhesive mixture is from 15-40 wt %, more preferably 16-35 wt %, particularly preferably 17-34 wt %, based on the total weight of the adhesive mixture.
96. Any one preceding embodiment, wherein ATH and alumina are both present in Component A and Component B.
97. Any one preceding embodiment, wherein the concentration of ATH in Component A is from 40-65 wt %, more preferably 43-60 wt %, particularly preferably 44-57 wt %, based on the total weight of the Component A, and the concentration of alumina in Component A is from 15-40 wt %, more preferably 16-35 wt %, particularly preferably 17-34 wt %, based on the total weight of the Component A.
98. Any one preceding embodiment, wherein the concentration of ATH in Component B is from 40-65 wt %, more preferably 43-60 wt %, particularly preferably 44-57 wt %, based on the total weight of the Component B, and the concentration of alumina in Component B is from 15-40 wt %, more preferably 16-35 wt %, particularly preferably 17-34 wt %, based on the total weight of the Component B.
99. Any one preceding embodiment, wherein the concentration of ATH in Component A is from 40-65 wt %, more preferably 43-60 wt %, particularly preferably 44-57 wt %, based on the total weight of the Component A, and the concentration of ATH in Component B is from 40-65 wt %, more preferably 43-60 wt %, particularly preferably 44-57 wt %, based on the total weight of the Component B, and the concentration of alumina in Component A is from 15-40 wt %, more preferably 16-35 wt %, particularly preferably 17-34 wt %, based on the total weight of the Component A, and the concentration of alumina in Component B is from 15-40 wt %, more preferably 16-35 wt %, particularly preferably 17-34 wt %, based on the total weight of the Component B.
100. Any one preceding embodiment, wherein Component A and Component B are mixed in a volumetric ratio A:B of 0.8-1.2.
101. Any one preceding embodiment, wherein Component A and Component B are mixed in a volumetric ratio A:B of 1.
102. Any one preceding embodiment, wherein the adhesive, after curing for seven days at 23° C. and 50% relative humidity shows a thermal conductivity of 1.5 W/mK or greater, more preferably 1.6 W/mK or greater, more particularly preferably 1.8 W/mK or greater, when measured according to ASTM 5470, as described in the Examples.
103. Any one preceding embodiment, wherein the adhesive, after curing for seven days at 23° C. and 50% relative humidity shows a lap shear strength of 1.5 MPa or greater, when measured according to DIN EN 1465, with a bonded area: 250 mm² (10×25 mm), adhesive layer thickness of 1 mm, using e-coated steel for both substrates.
104. Any one preceding embodiment, wherein the adhesive mixture resulting from mixing Component A and Component B has a working time of greater than 35 minutes, more preferably greater than 40 minutes, particularly preferably greater than 50 minutes, wherein working time is the time to develop a compression force of 150 KPa, when pressed into a 1 mm gap at a pressing rate of 62.5 mm/min by a parallel plate with a diameter of 50 mm.
105. Any one preceding embodiment, wherein the adhesive mixture resulting from mixing Component A and Component B has a compression force immediately after mixing of less than 80 KPa, more preferably less than 78 KPa, when pressed into a 1 mm gap at a pressing rate of 62.5 mm/min by a parallel plate with a diameter of 50 mm.
106. Any one preceding embodiment, wherein the adhesive mixture resulting from mixing Component A and Component B has a compression force 30 minutes after mixing of less than 130 KPa, more preferably less than 128 KPa, when pressed into a 1 mm gap at a pressing rate of 62.5 mm/min by a parallel plate with a diameter of 50 mm.
107. Any one preceding embodiment, wherein the adhesive mixture resulting from mixing Component A and Component B has a compression force 60 minutes after mixing of less than 160 KPa, more preferably less than 155 KPa, when pressed into a 1 mm gap at a pressing rate of 62.5 mm/min by a parallel plate with a diameter of 50 mm.

### EXAMPLES

TABLE 1
List of ingredients used in the Examples

| Trademark or | |
|---|---|
| abbreviation | Chemistry |
| WANNATE | mixture of 4,4′-diphenylmethane diisocyanate |
| MDI-50 | (50 wt %) and 2,4-diphenylmethane diisocyanate |
| | (50 wt %) |
| DONOL 1000 | Polypropylene glycol monomethyl ether |
| | Mn = 1000 g/mol, Functionality = 1 |
| NJ-330 | polypropylene glycol |
| | Mn = 3000 g/mol, Functionality = 3 |
| Dynasylan 9116 | hexadecyltrimethoxysilane |
| Fomrez UL-29 | dioctyltin mercaptide catalyst |
| JSLD4529 | inactive sky blue colour with diisononyl phthalate |
| | as solvent |
| Apyral 20X | Aluminium trihydroxide with bimodal particle size |
| | distribution: |
| | D₁₀ = 0.5 μm |
| | D₅₀ = 8 μm |
| | D₉₀ = 80 μm |
| WP2500 | Wollastonite fibre |
| CAB-O-SIL | Fumed silica |
| TS-720 | |
| SA 0050 | Spherical alumina with D₆₀ = 5.7 μm |
| SA 0700 | Spherical alumina with D₅₀ = 72 μm |
| PTSI | p-toluenesulfonyl isocyanate |
| NJ-204 | polypropylene glycol |
| | Mn = 400 g/mol, Functionality = 2 |
| Castor oil | Trifunctional polyol, with nominal molecular weight of |
| | 930.4 Da (triester of glycerol and ricinoleic acid) |
| CAPA 2201 | Polycaprolactone diol of mean molecular weight (Mn) |
| | 2,000 Da |
| Purmol 4st | Molecular sieves |

### Formulation of Adhesives

### Component a (Isocyanate)

### Prepolymer Preparation

The prepolymers were prepared in a 2 l four-necked flask equipped with a mechanical stirring bar and a thermometer. The isocyanate-terminated prepolymer was prepared by first mixing the mono-ol or polyol ingredient of Component A (either DONOL 1000 or NJ-330), and stirring under reduced pressure at 120° C. for 1 hour. The polyol was allowed to cool to 80° C., and the MDI-50 was added, and the mixture was allowed to react under reduced pressure at 80° C. for 2 hours. The material was then cooled to less than 30° C. The vacuum was broken under nitrogen, and the prepolymers were stored hermetically until use.

A specific description of the prepolymer process is provided for Inventive Example 5. 422 g of DONOL 1000 was added into a four-necked flask equipped with a mechanical stirring bar and thermometer at room temperature. The DONOL 1000 was dried under reduced pressure at 120° C. for 1 hour. The DONOL 1000 was allowed to cool to 80° C. and 528 g of MDI-50 was added into flask, and the mixture was allowed to react under reduced pressure at 80° C. for 2 hours. The material was cooled to less than 30° C. The vacuum was broken under nitrogen, and the prepolymer was stored hermetically until use. The prepolymer is prepared with an excess of isocyanate, resulting in predominantly NCO-terminated prepolymer.

To prepare Component A, using the quantities listed in Table 2, the Apyral 20X, SA0050, SA0700, WP2500 and CAB-O-SIL TS-720 were dried at 120° C. in an oven for 24 hours or longer until the moisture content was less than 300 ppm. The prepolymer, Dynasylan 9116, JSLD4529 and PTSI were added into a 2 l planetary mixer and mixed together for 10 minutes. The Apyral 20X, CAB-O-SIL TS-720 and WP2500 were added, and stirring was continued for a further 30 minutes at room temperature. The SA0050 and SA0700 were added, and stirring was continued, under reduced pressure, for an additional 30 minutes. The vacuum was then broken under nitrogen, and Component A was packaged in hermetic cartridges for storage until use.

A specific description of the preparation of Component A is provided for Inventive Example 5. The solids Apyral 20X, SA0050, S0700, WP2500 and CAB-O-SIL TS-720 were dried in 120° C. oven for at least 24 hours until the moisture content was less than 300 ppm. 190 g of prepolymer, 10 g of Dynasylan 9116, 1 g of JSLD4529 and 5 g of PTSI were added into 2 L planetary mixer laboratory scale mixer. After 10 minutes of mixing, 561 g of Apyral 20X, 13 g of CAB-O-SIL TS-720 and 20 g of WP2500 were added into mixer. Keep stirring for half an hour at room temperature, then, 75 g of SA0050, 125 g of SA0700 were added. The mixture is kept stirring under reduced pressure at room temperature for another half an hour. Finally, the vacuum is broken with nitrogen and the adhesive component can be filled in suitable packaging size.

### Component B (Polyol)

To prepare Component B (polyol), using the quantities listed in Table 2, the solid ingredients Apyral 20X, SA0050, SA0700, WP2500 and CAB-O-SIL TS-720 were dried at 120° C. in an oven for 24 hours or longer until the moisture content was less than 300 ppm. The liquid polyols (NJ-204 and Castor oil) were dried using molecular sieves until the moisture content was less than 300 ppm. The CAPA 2201 and Dynasylan 9116 were added as well as the dried solid ingredients, and stirring was continued for 30 minutes. The molecular sieves and Fomrez UL-29 were added and stirring was continued for an additional 30 minutes. The vacuum was broken under nitrogen, and Component B was filled in hermetic cartridges until use.

Components A and B were stored separately until use. Immediately before use, the components were mixed in a 1:1 volumetric ratio, and the following test were carried out.

### Working Time

The time after mixing to develop a compression force of 150 KPa. The results are listed in Table 2.

### Compression Force

10 g of adhesive resulting from mixing Components A and B in a 1:1 volumetric ratio is pressed into a 1 mm gap at a pressing rate of 62.5 mm/min by a parallel plate with a diameter of 50 mm. The force required is reported as compression force in KPa. The compression force was measured immediately after mixing (“initial”) and after 15, 30 and 60 minutes had elapsed (“open time”). The results are listed in Table 2.

### Lap Shear Strength

Lap shear strength was measured using DIN EN 1465, with a bonded area: 250 mm² (10×25 mm), adhesive layer thickness of 1 mm, using e-coated steel for both substrates. All surfaces were prepared by cleaning with isopropanol prior to application of the adhesive. The curing conditions were 7 days at 23° C. at 50% RH. Shear samples were pulled at 5 mm/min during the tests.

### Thermal Conductivity

Thermal conductivity was measured according to ASTM D5470. A thermal interface material tester from Linseis TIM D5470 was used for the test. The measurement was performed in Spaltplus mode between 1.5-3.0 mm thickness of adhesive after curing for 7 days at 23° C. and 50% RH. The absolute thermal conductivity λ (W/mK) was recorded. The results are listed in Table 2.

TABLE 2
Composition of Comparative Examples (CE) and
Inventive Examples (IE) and characteristics

| | CE1 | CE2 | CE3 | CE4 | IE5 | IE6 |
|---|---|---|---|---|---|---|
| Component A | | | | | | |
| WANNATE MDI-50 | [symbol] | [symbol] | [symbol] | [symbol] | [symbol] | [symbol] |
| [symbol] | [symbol] | [symbol] | — | — | — | — |
| DONOL 1000 | — | — | [symbol] | [symbol] | [symbol] | [symbol] |
| [symbol] | 1 | 1 | 1 | 1 | 1 | 1 |
| JSLD [symbol] | [symbol] | [symbol] | [symbol] | [symbol] | [symbol] | [symbol] |
| [symbol] | 2 | 2 | 2 | 2 | 2 | 2 |
| CAB-O-SIL TS-720 | [symbol] | [symbol] | [symbol] | [symbol] | [symbol] | [symbol] |
| [symbol] | [symbol] | [symbol] | [symbol] | [symbol] | [symbol] | [symbol] |
| SA [symbol] | — | — | — | [symbol] | [symbol] | [symbol] |
| SA [symbol] | — | — | — | [symbol] | [symbol] | [symbol] |
| PTSI | [symbol] | [symbol] | [symbol] | [symbol] | [symbol] | [symbol] |
| Component B | | | | | | |
| NJ-204 | [symbol] | [symbol] | [symbol] | [symbol] | [symbol] | [symbol] |
| Castor oil | [symbol] | [symbol] | [symbol] | [symbol] | [symbol] | [symbol] |
| CAPA 2201 | [symbol] | [symbol] | [symbol] | [symbol] | [symbol] | [symbol] |
| [symbol] | 1 | 1 | 1 | 1 | 1 | 1 |
| WP2500 | 3 | 3 | 3 | 3 | 3 | 3 |
| CAB-O-SIL TS-720 | [symbol] | [symbol] | [symbol] | [symbol] | [symbol] | [symbol] |
| [symbol] | [symbol] | [symbol] | [symbol] | [symbol] | [symbol] | [symbol] |
| SA [symbol] | — | — | — | [symbol] | [symbol] | [symbol] |
| SA [symbol] | — | — | — | [symbol] | [symbol] | [symbol] |
| [symbol] | 2 | 2 | 2 | 2 | 2 | 2 |
| [symbol] | [symbol] | — | [symbol] | [symbol] | [symbol] | [symbol] |
| Data | | | | | | |
| Working time (min.) | [symbol] | [symbol] | [symbol] | [symbol] | [symbol] | [symbol] |
| Compression force (KPa) initial | 133 | 133 | 121 | [symbol] | [symbol] | [symbol] |
| Compression force (KPa) after 15 | [symbol] | [symbol] | [symbol] | — | — | — |
| min. open time | | | | | | |
| Compression force (KPa) after 30 | [symbol] | [symbol] | 200 | 148 | 124 | 116 |
| min. open time | | | | | | |
| Compression force (KPa) after 60 | [symbol] | [symbol] | [symbol] | [symbol] | [symbol] | [symbol] |
| min. open time | | | | | | |
| Lap shear strength (MPa) | [symbol] | [symbol] | [symbol] | [symbol] | [symbol] | [symbol] |
| Thermal conductivity ( [symbol] ) | [symbol] | [symbol] | [symbol] | [symbol] | [symbol] | [symbol] |

[symbol]

indicates data missing or illegible when filed

### Results

Inventive Examples 5 and 6 both show a working time of significantly greater than 35 minutes (60 and >60 minutes, respectively), whereas the Comparative Examples show working times of 30 minutes or less.

Inventive Examples 5 and 6 show initial compression forces that are significantly less than the Comparative Examples, and the same is true at 15, and 60 minutes open time (time after mixing).

Inventive Examples 5 and 6 also show better thermal conductivities (≥2 W/mK) than the Comparative Examples (≥1.8 W/mK).

1. A two-component thermally-conductive polyurethane adhesive mixture, comprising:
(A) Component A comprising:
(ai) an NCO-terminated prepolymer made by reacting at least one polyether mono-ol of molecular weight (Mₙ) greater than 800 Da with at least one polyisocyanate selected from aliphatic polyisocyanates and mixtures of 2,4′-methylene-bis-(phenyl isocyanate) (MDI) and 4,4′-MDI; and
(B) Component B comprising:
(bi) at least one polyol; and
(bii) a catalyst capable of catalyzing the reaction of OH groups with NCO groups;
wherein Component A and/or Component B further comprise aluminum trihydroxide (ATH) in an amount such that when Component A and B are mixed to produce the adhesive mixture, the content of ATH in the adhesive mixture is at least 40 wt. % based on the total weight of the adhesive mixture, and wherein Component A and/or Component B comprise alumina in an amount such that when Component A and B are mixed to produce an adhesive mixture, the content of alumina in the adhesive mixture is at least 15 wt. % based on the total weight of the adhesive mixture.

2-107. (canceled)

108. The adhesive of claim 1, wherein the polyether mono-ol is selected from monoethers of poly(C₂₋₄-alkylene oxide) diols, and monoesters of poly(C₂₋₄-alkylene oxide) diols.

109. The adhesive of claim 108, wherein the polyether mono-ol is selected from monoethers of poly(ethylene oxide) diols, monoethers of poly(propylene oxide) diols, monoethers of poly(butylene oxide) diols, and mixtures thereof.

110. The adhesive of claim 109, wherein the polyether mono-ol is selected from monoethers of poly(propylene oxide) diols.

111. The adhesive of claim 110, wherein the polyether mono-ol is selected from terminal methyl, ethyl and propyl monoethers.

112. The adhesive of claim 111, wherein the polyether mono-ol is selected from terminal methyl monoethers.

113. The adhesive of claim 1, wherein the polyisocyanate is a mixture of 2,4′-MDI and 4,4′-MDI.

114. The adhesive of claim 113, wherein the polyisocyanate is a mixture of 2,4′-MDI and 4,4′-MDI and wherein the weight ratio of 2,4′-MDI to 4,4′-MDI is 0.667-1.5.

115. The adhesive of claim 114, wherein the polyisocyanate used to make the prepolymer is a mixture of 4,4′-MDI and 2,4-MDI, with a 1:1 weight ratio of 4,4′-MDI and 2,4-MDI.

116. The adhesive of claim 1, wherein the at least one polyisocyanate is used in a stoichiometric excess of 2-15-fold with respect to the mono-ol.

117. The adhesive of claim 1, wherein the at least one polyol comprises diols, triols or a mixture thereof.

118. The adhesive of claim 1, wherein the at least one polyol comprises castor oil.

119. The adhesive of claim 118, wherein the at least one polyol comprises a polyether diol and castor oil.

120. The adhesive of claim 119, wherein the at least one polyol comprises a mixture of polyether diol having molecular weight of less than 600 Da and castor oil.

121. The adhesive of claim 120, wherein the at least one polyol comprises a mixture of a poly(propylene oxide)-based diol and castor oil.

122. The adhesive of claim 121, wherein the at least one polyol comprises a mixture of a poly(propylene oxide)-based diol having a molecular weight of less than 600 Da and castor oil.

123. The adhesive of claim 1, wherein Component B comprises 4-10 wt. % of a poly(propylene oxide) diol having molecular weight of less than 600 Da, based on the total weight of Component B, and 5-20 wt. % of castor oil, based on the total weight of Component B.

124. The adhesive of claim 1, wherein the catalyst is selected from tertiary amine catalysts and organometallic catalysts.

125. The adhesive of claim 124, wherein the catalyst is selected from alkyl tin carboxylates, oxides and tin mercaptides.

126. The adhesive of claim 125, wherein the catalyst is dioctyltin mercaptide.
